(19) United States
(12) Patent Application Publication
(10) Pub. No.: US 2005/0089644 A1
(43) Pub. Date: Apr. 28, 2005

(54) Method for sealing a building panel

(76) Inventor: Frank Oldorff, Schwerin (DE)

Correspondence Address: Andrew M. Calderon;McGuire Woods LLP, Suite 1800, Tysons Corner, 1750 Tysons Boulevard, McLean, VA, 22102-4215, US

(21) Appl. No.: 10/932,337

(22) Filed: Sep. 2, 2004

(30) Foreign Application Priority Data
Sep. 6, 2003 (DE) 103 41 172.0

(51) Int. Cl. B05D 3/02

(52) U.S. Cl. 427/393; 427/370

(57) ABSTRACT

A process for sealing a construction plate of wood or a wood material, having a top side and a bottom side, with the following steps: a) application of a liquid resin to the top side, b) drying of the resin, and c) pressing the construction plate under the influence of temperature, so that the resin at least partially melts.

### FIELD OF THE INVENTION

The invention relates to a process for sealing a construction plate of wood or of a wood material having a top side and a bottom side.

### BACKGROUND DESCRIPTION

Construction plates may be floor boards, such as parquet; sheathing boards, or sheets for furniture building. These plates are made of solid wood, especially doweled and glued wood, or they may consist of a core of a wood material such as MDF, HDF (medium-density fiberboard, high-density fiberboard) or floor plates onto which a real wood veneer is cemented. OSB boards (Oriented Strand Boards) are the principal sheathing boards used.

The surfaces of these plates must be sealed to protect them from environmental influences. Penetration of moisture in particular must be prevented for floor boards. The surface of the board is often painted for that purpose. Paint is relatively soft, and the paint coat is subject to wear, especially in parquet floors, so that the floor must be resealed often. In closed spaces, that is linked with unpleasant features, as the old coat of paint must be sanded off before a new one can be applied. The fine sanding dust deposits everywhere, and then must be tediously removed.

Laminated panels are sealed with a coating of synthetic resin. To produce laminated panels, a paper sheet printed with a pattern is laid on a carrier board of MDF, HDF or chipboard, on which has been laid an overlay, a layer of synthetic resin or a paper layer soaked with synthetic resin. Then the board is pressed, with heating, so that the overlay, including the paper layer, bonds to the surface of the board. For floorboards, corundum particles are incorporated in the finished overlay to increase resistance to wear. Then individual panels are sawed out of the boards so produced.

A resin is not only less expensive than paint, but also harder. Placing the paper sheet or a ready-made overlay onto the top side of the plate of wood material must be done carefully. Handling of the very thin layers is complicated and requires precisely operating machines so as to make sure that only one individual layer of the overlay is lifted from a stack. For a laminated plate, the bottom side must be given an “undercoat” that compensates for the tensile stresses produced on the plate core by the decorated layer in order to prevent bending of the plate, and especially of the panels sawed out later, in the longitudinal direction.

A parquet structure is known from EP B1-0 560 870, in which a filler resin or paint is impregnated into the interior and into the intermediate spaces of the vertical grain of the wood, under the varnish layer which forms the surface coating, so that the amount of the paint is several times greater than the amount of the parquet varnish. After the filler resin has penetrated in, the boards are preheated. After cooling they absorb the resin down to a sufficient depth to form a “barrier layer” which prevents the expensive varnish penetrating in too deeply when the parquet is later sealed. This measure provides harder surfaces than the usual sealed parquetry with the same consumption of varnish.

It is known from DE C2-37 35 368 that a powdered resin layer can be scattered on a plate of material and then pieces of inlay can be placed on that. Then the powder layer is hot-pressed to melt the resin and bond it to the plate.

### SUMMARY OF THE INVENTION

Based on that statement of the problem, a process will be described for sealing a construction board of wood or a wood material with a real wood surface, with which the wear-resistant surface known for laminated plates can be attained, but which is simpler and can be carrier out faster.

### DETAILED DESCRIPTION OF EMBODIMENTS OF THE INVENTION

The solution of the problem is arrived at through the following steps:

a) applying liquid resin to the top side,

b) drying the resin,

c) pressing the construction plate under the influence of temperature, so that the resin at least partially melts.

The liquid resin can be rolled on, sprayed on, or poured on. It is considerably easier to handle than a premade resin layer. If the resin layer is applied correspondingly thick, the surface hardness known for laminated plates is produced. Thus it is possible to provide a construction plate which combines the positive properties of solid wood or veneered wood material with the positive properties of a laminate. The considerably harder resin gives very high wear resistance, which can be increased even more by mixing corundum particles into the liquid resin, or by scattering them on it.

Use of appropriately polished press surfaces in the press can produce degrees of gloss on pressing the construction plate. A press plate polished to a high gloss results in highly glossy or even reflective surfaces. That can generate particularly beautiful visual effects. An OSB plate can be smoothed to eliminate unevennesses in the surface before application of the resin coating.

The bottom side of the construction plate can be sealed in the same manner. Then OSB plates in particular, which exhibit very high strength, can be used as concrete form sheets. Not only does the synthetic resin layer prevent penetration of moisture into the form sheet, but it also increases its life because of the hardness of the surface.

The resin can be applied in multiple layers, with each layer being dried before the next is applied.

It is preferable for the resin to be a synthetic resin, especially a melamine resin.

The resin can be stained to produce special visual effects. A color layer can be applied between the resin layers on the top or bottom sides. The color layer can be printed. That has the advantage that the appearance can be improved. For instance, an oak or rosewood pattern, with the appropriate grain and color, can be applied to a pine veneer, increasing the value of the real wood surface.

A relief matching the pattern (of the wood grain) can be embossed in the resin layer on pressing so as to match the feel of the sealed surface to that of the unsealed wood.

Other fillers can also be mixed into the resin layer, or sprinkled onto individual layers. Application of such a layer to the bottom side can, for instance, improve the impact sound characteristics of a floor board.

It is preferable to coat the top and bottom sides at the same time. Not only does that provide completely new and improved product properties, but it also simultaneously makes a substantial reduction in the production cost of the construction plate.

1. A process for sealing a construction plate of wood or a wood material, having a top side and a bottom side, with the following steps:
applying a liquid resin on the top side,
drying the resin, and
pressing the construction plate under the influence of temperature so that the resin at least partially melts.

2. The process according to claim 1, further comprising the following steps:
application of the resin to the bottom side,
drying the resin,
pressing the construction plate under the influence of temperature so that the resin at least partially melts.

3. The Process according to claim 1 or 2, wherein the resin is applied in multiple layers and each layer is dried before the next is applied.

4. The process according to one or more of the foregoing claims, wherein the resin is a synthetic resin, especially a melamine resin.

5. The process according to one or more of the foregoing claims, wherein the resin is stained.

6. The process according to one or more of the foregoing claims, further comprising a color layer is applied on the top side or on the bottom side under or between the resin layers.

7. The process according to claim 1 or 2, further comprising a relief is embossed into the resin layer on pressing.

8. The process according to claim 1 or 2, wherein corundum is mixed into or scattered onto the resin layer.

9. The process according to claim 1 and 2, wherein the sealing is performed simultaneously on the top side and the bottom side.

10. The process according to claim 1, 2 or 9, wherein the pressing is performed in a continuous press.
